(19) United States
(12) Patent Application Publication
(10) Pub. No.: US 2015/0268027 A1
(43) Pub. Date: Sep. 24, 2015

(54) ELECTRIC FIELD SENSING AND E FIELD VISUALIZATION

(71) Applicant: MEDUSA SCIENTIFIC LLC, Tucson, AZ (US)

(72) Inventor: Richard C. Gerdes, Tucson, AZ (US)

(21) Appl. No.: 14/430,154

(22) PCT Filed: Mar. 14, 2014
(86) PCT No.: PCT/US14/28591

§ 371 Date: Mar. 20, 2015

Related U.S. Application Data
(60) Provisional application No. 61/798,085, filed on Mar. 15, 2013.
(60) Provisional application No. 61/798,221, filed on Mar. 15, 2013.
(60) Provisional application No. 61/798,172, filed on Mar. 15, 2013.
(60) Provisional application No. 61/798,038, filed on Mar. 15, 2013.
(60) Provisional application No. 61/794,726, filed on Mar. 15, 2013.

(51) Int. Cl. G01B 7/008

(52) U.S. Cl. CPC G01B 7/008

(57) ABSTRACT

A method and system is provided for visualization of E fields in which a high impedance low noise amplification system is coupled to an E field sensor for real time imaging of the E field in either one, two or three dimensions. The sensitivity of the system is enhanced by directional antennas and applications include particle counting and hand gesture recognition.

This application claims priority from U.S. Provisional Application Ser. Nos. 61/794,726, filed Mar. 15, 2013; 61/798,038, filed Mar. 15, 2013; 61/798,172, filed Mar. 15, 2013; 61/798,221, filed Mar. 15, 2013 and 61/798,085, filed Mar. 15, 2013, the contents of which are incorporated herein by reference.

Specialized analog circuitry, signal processing and antenna designs provide for sensitive and robust E field detection that permits real-time multidimensional E field imaging for visualization and applications including particle detection and hand gesture recognition. More particularly, the present invention is in the technical field of imaging and display of electrostatic-charge E-Fields for live or real time imaging and display of the E-Fields. Further, the present invention relates to live or real time one, two or three dimensional imaging and display of electrostatic-charge E-Fields.

Prior art has relied on measuring ambient static charge levels at specific point locations, mapping the measured data and visually presenting the data in a manner that is not simultaneous with measurements. Thus there is a need for real time imaging of E fields.

E fields exist in nature but are rarely visualized. This means that the E field pattern is not presented as to what the E field looks like. Moreover, circuitry does not presently exist that will reliably detect the miniscule static E fields or changes in E fields so as to be able to provide for robust E field detection, imaging and other applications.

In general, E field sensing has been utilized in proximity detection in which an alternating current electric field is generated, with the receipt of the alternating electric field being utilized to detect the presence of a stationary object or moving object between the transmitting site in the receive site.

While proximity sensors utilizing E field detection are known, these are in general short range devices which can sense the presence of a finger adjacent tablet or screen, but are not generally useful to detect where in three-dimensional space a particular object is. Thus, for example tablets may employ electric field sensing apparatus to detect when a person's finger is above a given position on a screen. This is not done with any positional accuracy. While the above is a non-tactile sensing system, it is not used for detecting the E field pattern or displaying it, much less detecting particular points in the field that have been perturbed by the presence of a conductive or partially conductive object.

There is therefore a need to provide analog circuitry that will robustly detect the fields and to be able to provide one dimensional, two dimensional or three dimensional imaging of the E field for real time E field visualization, as well the accurate position of an object in an E field. Further there is a need for improved E field antennas or antenna arrays to permit such real time imaging and for other applications such as particle counting, hand gesture recognition and intrusion detection.

A combination of specialized analog circuitry, antenna design and signal processing permits the sensing of the ambient E field so that the E field pattern can be visualized as to what it looks like in space. The result for static fields is a mosaic or pattern of the E field flux lines with each charge identified as an image or picture element on the mosaic. For moving objects the disturbance in the E field is detected and a moving image or picture element generated at the point of the disturbance to be able to track the moving object.

In one embodiment, E field visualization is accomplished by three mutually perpendicular antennas so that a 3 dimensional image of charged objects within a volume of space can be presented on-screen. The image contains a visually accurate image of the location of charged objects within the sensed volume, with quantitative information of charge magnitude being separately available as onscreen data along with accurate positional information.

Multichannel processing from three mutually perpendicular antennas permits one dimensional, two dimensional or three dimensional rendering of the E field, with digital signals used to drive the inputs of a 3 dimensional software driven display system that provides both measurement data and volumetric display on a computer screen.

The above specialized circuitry utilizes unique antenna designs to make possible visualization of the fields, with the antenna design and signal processing permitting sensing minute changes in the input charge level that creates a means for detecting charged particles. Antenna designs include a simple rod antenna design for an omni-directional characteristic or a short rod within a cylindrical shield to provide a directional characteristic. A split rod antenna provides an ellipsoidal directional characteristic, whereas the introduction of a short rod antenna into a cylindrical shield that forms a conduit for particles permits precise particle counting.

Because of the ability to sense tiny changes in the ambient E field a planar segmented antenna provides the ability to sense hand gestures, with signal processing involving interpretation of the sensed hand gesture pattern or movement to produce one or more separate sensed features for machine control. In one embodiment 28 different movement patterns can be detected, with extended finger patterns producing patterns for decoding as many as 73 control functions.

In one embodiment of the subject invention a specialized analog circuit is provided having an integrating amplifier connected to an E field sense antenna, with the output of the integrating amplifier coupled to the input of an integrating feedback amplifier, in turn coupled to a nonlinear device to establish a baseband against which minute changes in the E field at the input to the integrating amplifier are measured.

In this embodiment the output of the first integrating amplifier drives the input to a second integrating amplifier serving as a feedback amplifier that produces an output voltage. The output of the integrating feedback amplifier is coupled to the input charge as sensed by the E field antenna coupled to the input to the first integrating amplifier. This connection is to cancel the input charge in order to drive the output of the first integrating amplifier to zero. This is done with a non-linear device made up of anti-parallel diodes where the impedance is low when there is a voltage difference between the antenna input and the output of the integrating feedback amplifier output. When balance has been reached, there is a small potential difference and the anti-parallel diodes exhibit a high impedance required for low noise static E field detection. This small potential difference is related to the static ambient charge sensed by the antenna, and when linearly amplified results in an increased voltage. E field charge increase or movements of charged objects produce voltage changes from zero. This amplified voltage may be thresholded to discriminate against small E field changes yet indicate when large changes have occurred.

As a result, accurate noise free measurement of the E field is accomplished. Note that in order to provide noise free E field detection, an ambient static baseline charge output is established at the output of the integrating feedback amplifier that is subtracted from the input to the integrating amplifier to establish a small potential difference related to the sensed static ambient charge.

Utilizing this specialized analog circuitry, real time three dimensional imaging is possible that permits seeing the E field in real time in terms of a visually accurate image of the location of charged objects within the sensed volume. In one embodiment the multi-dimensional process incorporates multi-axis sensing coupled with high impedance, low noise and high gain amplification for each channel, followed by analog signal processing in both frequency and amplitude domains and analog-to-digital conversion followed by signal processing prior to display.

As an example of the use of this specialized analog circuitry, sensitive E-field based particle counting is made possible by the subject sensing system. Moreover, the design of specialized E field antennas having directionality improves on particle detection as well as visualization.

E field hand gesture detection for machine control is also enabled by the subject analog detection circuitry as well as gesture recognition algorithms that take advantage of the ability to establish by E field sensing where in space a hand or finger is.

Thus, the ability to establish noise free detection of static E-fields permits real time imaging of the E field in multiple dimensions and also makes possible the use of specialized sensing antennas that can further pinpoint a point in space where a particular E field event is occurring. As a result, the above establishes the viability of a large number of E-field based applications.

These and other features of the subject invention will be better understood in connection with the Detailed Description, in conjunction with the Drawings, of which:

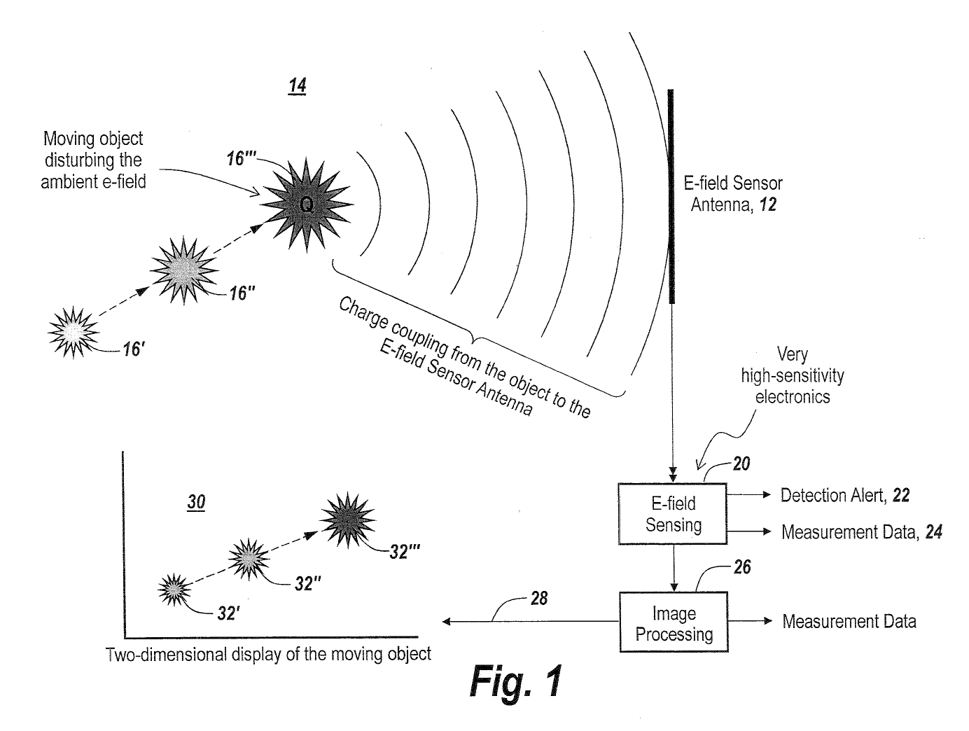

FIG. 1 is a diagrammatic illustration of an imaging system for imaging an E field in two dimensions, indicating the display of an object moving in the E field;

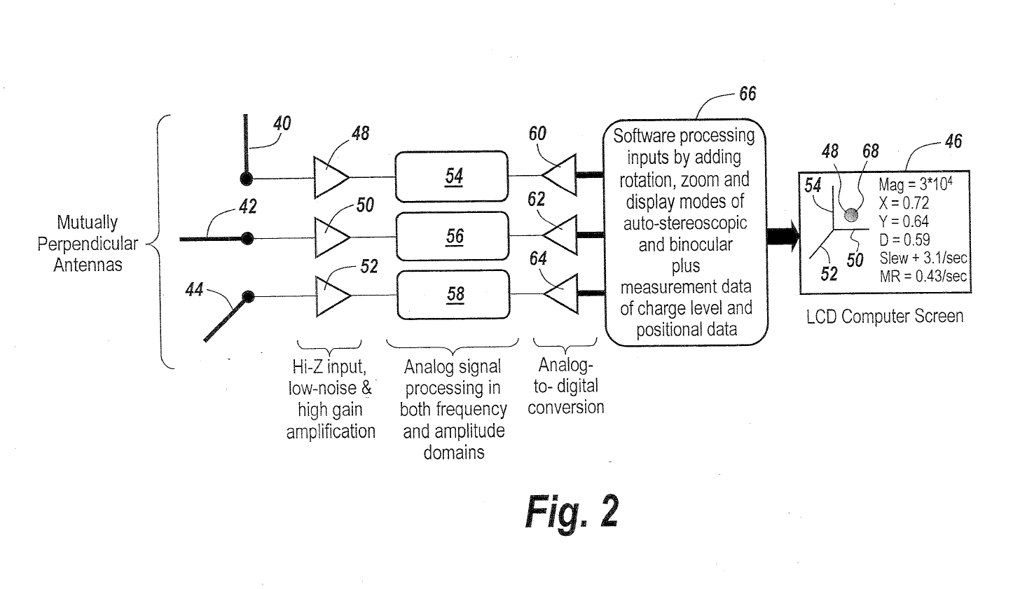

FIG. 2 is a diagrammatic illustration of a three dimensional imaging system involving orthogonal E field sensors, HI-Z, low noise, high gain amplification, analog and digital processing and 3D display of E field detected objects and corresponding data;

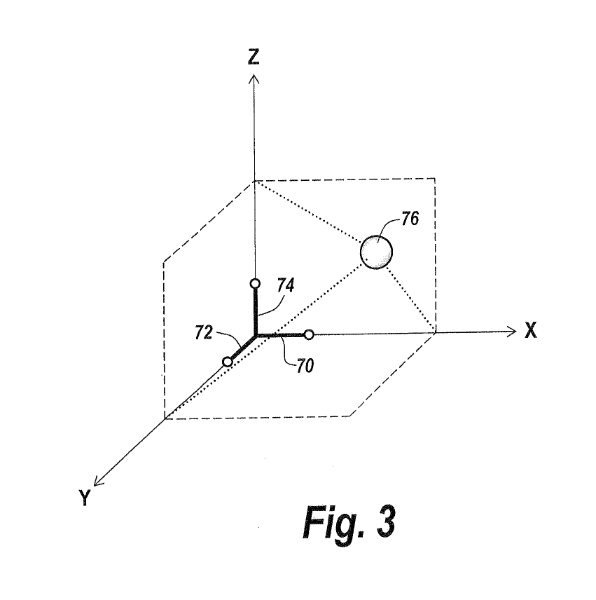

FIG. 3 is a diagrammatic illustration of three orthogonal E field sensors and the localization of an E field data point in a three dimensional imaging system;

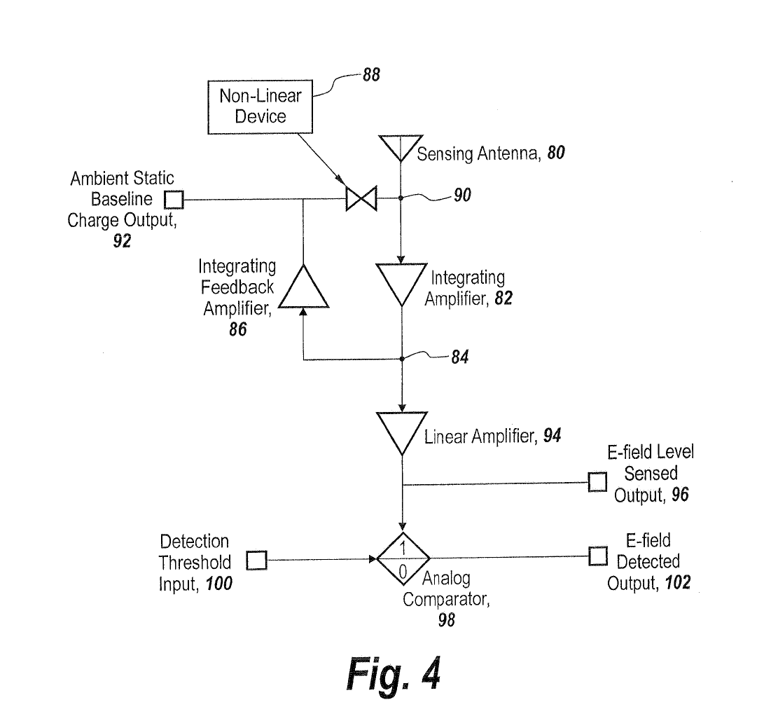

FIG. 4 is a diagrammatic illustration of a specialized analog E field sensing circuit that provides a Hi-Z, low noise amplified E field value for E field applications;

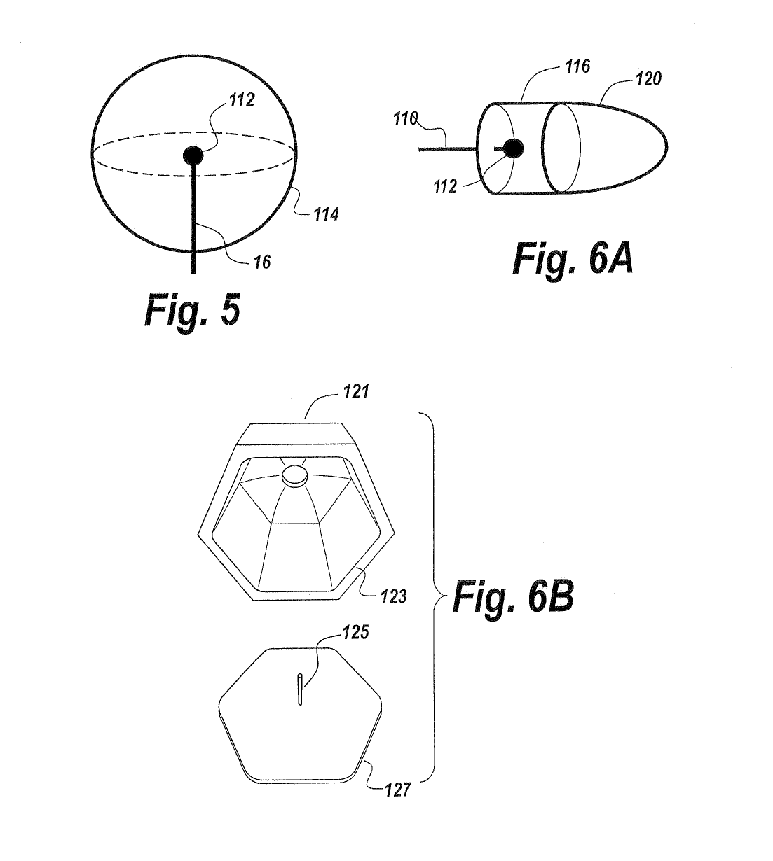

FIG. 5 is a diagrammatic illustration of an E field sensor for omni-directional coverage;

FIG. 6A is a diagrammatic illustration of an E field sensor for directional E field coverage involving a rod partially inserted into a conductive cylinder;

FIG. 6B is a diagrammatic illustration of the E field sensor of FIG. 6A in hexagonal form;

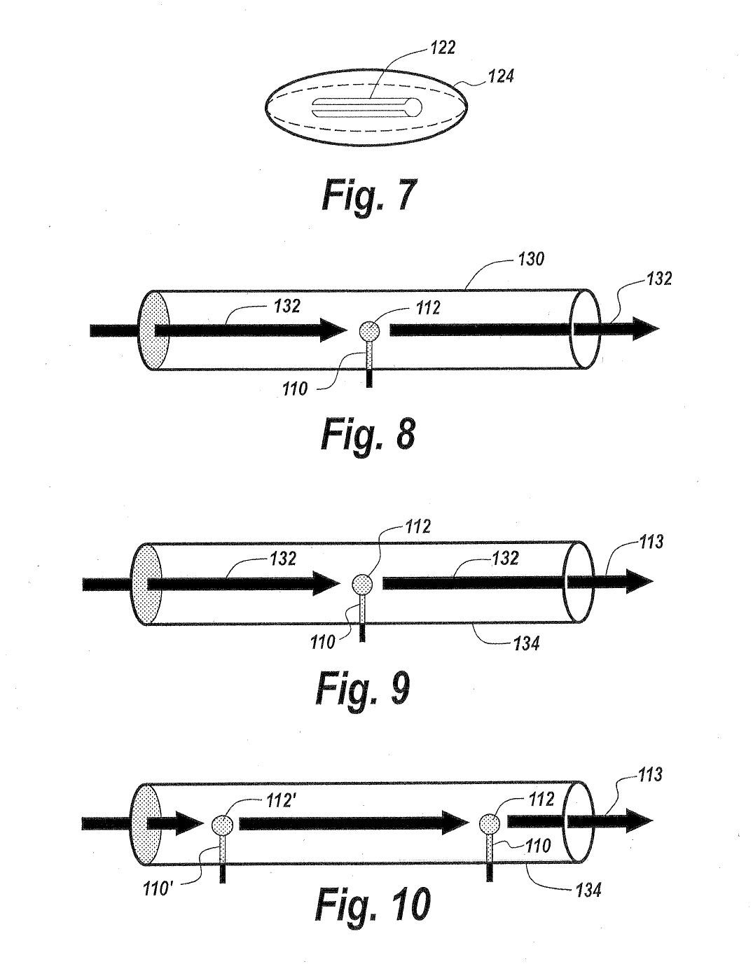

FIG. 7 is a diagrammatic illustration of a slotted tube E field sensor having ellipsoidal coverage;

FIG. 8 is a diagrammatic illustration of a sensor configuration for having bidirectional cylindrical coverage;

FIG. 9 is a schematic diagram of the use of an upstanding rod in a flow tube for use in particle counting;

FIG. 10 is a diagrammatic illustration of the use of a pair of upstanding rods in a flow tube for use in particle counting;

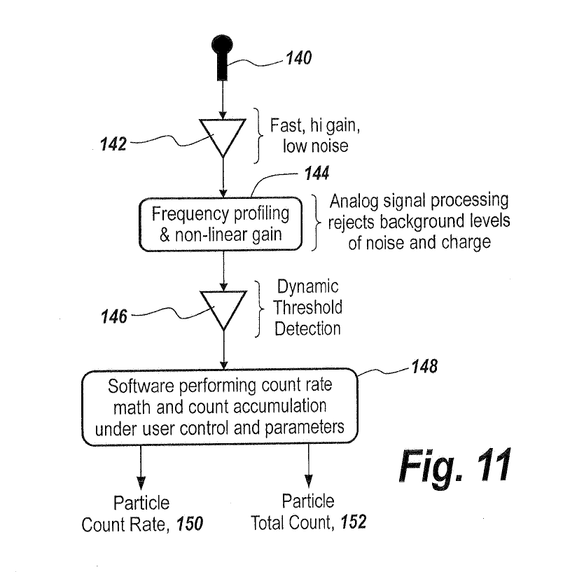

FIG. 11 is a diagrammatic illustration of a processing system for counting particles in the tubes of either FIG. 9 or 10 indicating fast high gain, low noise amplification, background rejection, dynamic thresholding and particle rate counting; and,

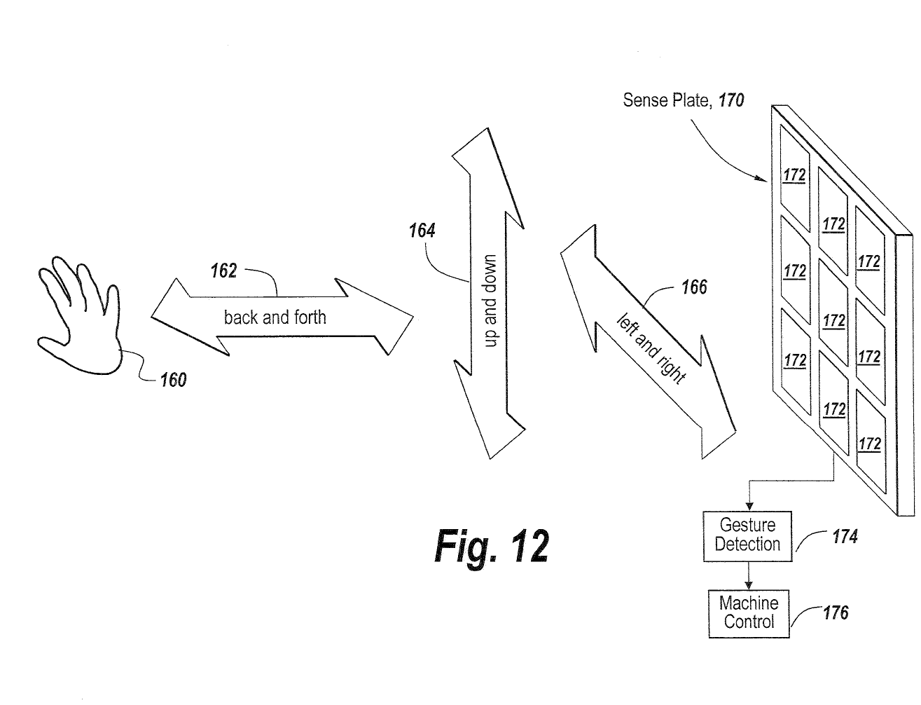

FIG. 12 is a diagrammatic illustration of a hand gesture detection and machine control system utilizing sensed E fields and a segmented planar E field sensor.

Prior to going into the details of the subject invention, and referring now to the invention in more detail, the present invention in one embodiment is a system comprised of a set of signal processing steps that takes signals from an E-Field sensing system and formats the signals so that they conform to the display system inputs for visual or graphical presentation in physical locations that are representative of the physical locations of the corresponding E-Field sense antennas.

In one embodiment a one dimensional set of E-Field sensors is displayed as a single linear row or axis of indicators or image or picture elements such that the location of the visual display elements are related to the physical locations of corresponding E-Field sense antennas.

A two dimensional set of E-Field sensors is displayed as a perpendicular set of two linear axes forming an array of indicators or image or picture elements such that the location of the visual display elements are related to the physical locations of corresponding E-Field sense antennas and their respective two dimensional array of locations.

A three dimensional set of E-Field sensors is displayed as a mutually perpendicular set of three linear axes forming an array of indicators or image or picture elements such that the location of the image or picture elements are related to the physical locations of corresponding E-Field sense antennas and their respective three dimensional array of locations.

The signal processing, for two dimensional sensing involves the correlation of the signal of the X-axis, at time a, to the signal on the Y-axis at time a. This would locate the charge object at the coordinates of X(a) and Y(a).

The signal processing, for three dimensional sensing, involves the correlation of the signal of the X-axis, at time b, to the signal on the Y-axis, at time b, with the signal on the Z-axis, at time b. This would locate the charge object at the coordinates of X(b), Y(b) and Z(b).

The signal processing, for three dimensional display of a two dimensional array of sensors, would involve the correlation of the signal of the X-axis, at time c, to the signal on the Y-axis, at time c, along with the interpolation of the signal amplitudes, amplitude and phase and location changes with extrapolation of the resulting signal on the Z-axis, at time c. This would locate the charge object at the coordinates of X(c), Y(c) and Z(c). How this is done in real time and with exceptional sensitivity is now described.

Referring now to FIG. 1, what is shown is an E field sensor antenna 12 adapted to detect the E field charge for objects within a given volume 14. As shown, a conductive object 16 moves from the position 16′ to a position 16″ and finally to a position 16′″ where there is a charge coupling from the object to the E field sensor antenna. Extremely sensitive E field electronics 20 are coupled to the output of the E field sensor antenna 12 that supplies in one embodiment an alert 22, and in another embodiment measurement data 24 based on the sensed E field from E field sensor antenna 12.

The output of the E field sensing electronics 20 is coupled to an image processing module 26 which outputs data over line 28 to a display 30 that images the E field in a two-dimensional display to portray the position of the moving object as an icon or image or picture element illustrated at 32′, 32″ and 32″′.

It will be appreciated that what is measured is the E field environment in volume 14 at various positions corresponding to the positions 32′, 32″ and 32′″ relating to the position of an object, namely a conductive or partially conductive object such as a person. This is done in terms of the distance of this object from the E field sensor antenna 12. By virtue of measuring the distance from the perceived disturbance of the E field one can render an image on two-dimensional display 30 of the presence of the disturbance as well as the distance of the disturbance relative to the E field sensor antenna. Note this rendering can be done in real time. The object may be conductive, partially conductive or non-conductive, since non-conductive objects also may have a charge-excess electrons (negative charge)—or lack of electrons (positive charge).

As will be seen, the subject system is arranged to determine the presence of an object that is moving within the E field, such that the disturbances in the E field caused by the movement of the conductive, partially conductive or non-conductive object is what is imaged in terms of image or picture elements reflecting the charge due to the disturbance.

Because of the sensitivity of the subject system, it is also possible for the system shown in FIG. 1 to present static objects within volume 14, as opposed to moving objects. In one embodiment the static indication is an image or picture element or icon reflecting the E field value for the field that exists at a point within volume 14. A mapping of all of these static points presents a rendering of the E field lines of flux as points or image or picture elements whose pattern reflects the charge values across the detected volume and thus the E field flux space. The E field is thus presented as a mosaic that makes the field easily understood.

It will be noted that the ability to provide an E field image is directly the result of E field sensing apparatus 30 which as will be described connection with FIG. 4 is a highly sensitive, low noise circuit capable of detecting even the minutest electrical charge within the given sensing volume. As a result, the sensing system does not require the transmission into the sensing volume of electromagnetic energy of a given frequency, the properties of which are disturbed based on objects within the volume. Rather the system directly measures the pinpoint charges within the volume that produces the E field. Having been able to sense the miniscule charges within the E field, an image thereof is rendered in terms of position with respect to an E field sensor antenna. An even more robust indication of objects within the field can be had if the object is in fact moving. The fact that it is moving can be detected by a dQ/dt type of detector which provides a robust measurement of the position of the moving object within the E field.

While the system shown in FIG. 1 relates to a two-dimensional imaging system for providing an indication of an E field charge within an x-y coordinate system, as shown in FIG. 2 one can use mutually perpendicular antennas 40, 42 and 44 with the result being the 3 D imaging of a point within the volume 14 of FIG. 1. This is provided by a display 46 in which the particular E field object 48 is located in a three-dimensional space along axes 50, 52 and 54 corresponding to the X, Y, and Z axes.

In order to be able to provide such a sensitive the display and indeed sensitive imaging, high input impedance, low noise, high gain amplification is provided as illustrated at 48, 50 and 52. Three channels of information corresponding to the outputs of the three mutually perpendicular antennas 40, 42 and 44 are input to analog signal processing modules 54, 56 and 58 that process the analog signals in terms of both frequency and amplitude domains. Thereafter, as illustrated at 60, 62 and 64 the signals in each of the channels is the converted from analog data to digital data in an analog to digital conversion step. The output of the analog-to-digital converters 60, 62 and are applied to a signal-processing module 66, where the signal processing adds rotation, zoom and display modes as well as auto stereoscopic and binocular processing. The signal-processing module also outputs measurement data in terms of charge level and positional data which is coupled to display 46 as illustrated.

In so doing the miniscule charge data that is available at the mutually perpendicular antennas can be processed to provide the distances from these three mutually perpendicular antennas to be able to locate a conductive object.

Once having been able to measure the exact distance of an object to each of the three mutually perpendicular antennas, triangulation permits location of the image of object 48 on display 46. How the high impedance input, low noise, high gain amplification is performed will be discussed in connection with FIG. 4.

However referring to FIG. 3, the orientation of three E field sensing antennas 70, 72 and 74 is illustrated in which these antennas align with the x axis, the y-axis in the z-axis. An object 76 relative to these antennas is detected in terms of the distance between the object and the closest approach to each of these antennas, such that if the object 76 is within volume 14, its location relative to these three antennas can be imaged as illustrated in FIG. 3 in terms of an image or picture element or icon.

Note that the exact distance of the object from each of the antennas is determined by the charge level that is detected by each of the antennas. Each of the antennas has a predetermined antenna lobe from which the distance of an object to the antenna can be measured in terms of the detected charge level. If the antennas are given a directional characteristic, then the accuracy of geolocation within the volume is increased. However will be appreciated that if the antennas have omni-directional patterns, the overlay of these patterns will nonetheless produce an unambiguous location of the particular object within the volume.

As a result of E fields presented in the above manner, the image contains a visually accurate image of the locations of the charged objects within the sensed space or volume. Moreover, quantitative information related to charge magnitude is separately available either as on-screen data, or externally presented data as well as positional information.

The volume of space presented in the display is a function of the E field antennas and their placement. Each axis in the illustrated embodiment represents an antenna for each channel of sensing. The three antennas ideally have the same length in order to define a cubic space, with the antennas in one embodiment connected to their respective electronics by interconnecting cables at the point where the three antennas meet. Note that the three axes have identical electronics and provide signals that are used by three-dimensional display system electronics consisting of very highly sensitive analog input electronics followed by amplification, signal processing and analog-to-digital conversion described in connection with FIG. 4.

The digital signals drive inputs of a 3-D software-driven display system that provides both measurement data and volumetric display on a computer or tablet screen. The software provides image manipulation for viewing the charge field from any external point of view.

The system described above is shown as a network of blocks representing the parts of an instrument that send signals to a computer for use by the 3-D software. The computer display shown is a replica of the actual sensed space. Display and software methods are used to determine whether glasses are needed how much manipulation of the image is available. The system of FIG. 3 thus describes three-dimensional imaging of the E field that permits seeing the field in real time.

The unique analog circuit design of FIG. 4 and antennas to be described permits sensing minute changes in the ambient E field that produces the means to detect such things as harmful charge objects such as for instance high voltages in static charges or those associated with such household objects as cleaning dusters. Note that the measured data gives nonvisual information such as actual charge values, how fast the charge may be growing and how it is moving.

Note that the E field can be viewed as a long one dimensional line, in a two-dimensional flat area or for instance in, a three-dimensional space. Note also that the ability to visualize the E field conveys real-time knowledge of any movements within the field of view as well as a mapping or visualization of static E fields.

Referring now to FIG. 4, what is shown is a specialized analog circuit for sensitively detecting E field charge in a robust and noise free manner.

What will be seen is that a sensing antenna 80 is coupled to the input of an integrating amplifier 82 having its output 84 fed back to an integrating feedback amplifier 86 that is in turn coupled through a nonlinear device 88 to the output of sensing antenna 80 as illustrated at 90. The output of the integrating feedback amplifier constitutes an ambient static baseline charge output 92 against which the E field assessed by the sensing antenna 80 is compared.

It will be appreciated that the output of the integrating amplifier 82 is coupled to a high gain linear amplifier 94, the output of which is illustrated at 96 as the sensed E field level output of amplifier 94. Output 96 is coupled to an analog comparator 98 having as one input thereof a detection threshold input 100. When the output of linear amplifier 94 is thresholded, output 102 is utilized to robustly detect the presence of an object within the aforementioned E field.

In operation, sensing antenna 80 has a coupled E field charge associated with it, with the antenna being either a single wire, a segmented antenna, or a multiple element array.

The output of the sensing antenna 80 is the input charge from the antenna applied to the integrating amplifier 82. The antenna input charge produces an integrated output Vout=Q/C where C is the integration capacitance and Q is the input charge.

The output of the integrating amplifier drives the input integrating feedback amplifier 86 that produces an output voltage applied to a nonlinear device 88. The output of the integrating feedback amplifier is thus coupled to the input charge sensed by the antenna through nonlinear device 88. This connection is to cancel input charge in order to be able to drive the output of the integrating amplifier to zero. This is done with the aforementioned nonlinear device made up of antiparallel diodes where the impedance is low when there is a voltage difference between the antenna input and the output of the integrating feedback amplifier output. When balance has been reached, there is a small potential difference and high impedance associated with the anti-parallel diodes. The small potential difference is related to the static ambient charge sensed by the antenna.

The integrating amplifier output 94 is amplified in a linear manner to increase the voltage. When monitoring moving particles, movement of charged particles produces output voltage changes from zero that are available at 96. The output voltage from the linear amplifier is compared with a threshold voltage 100 that is used to discriminate against small E field changes to indicate when large changes have occurred.

Referring to FIG. 5 the sense antenna may be a simple rod antenna 110 having a ball 112 at the top this antenna, with this antenna having an omni-directional characteristic 114 as illustrated.

Referring to FIG. 6A, a rod 110 is made to extend into a cylindrical conductive housing 116. As a result the shape of the antenna pattern for this antenna is directional as illustrated at 120. This housing may be cylindrical or have a hexagonal cross section as illustrated in FIG. 6B. More specifically, the present invention may be comprised of a hexagonal shaped cup-like conductive shield or enclosure 121 having an open end 123 and a sensitive element 125 inside of the enclosure and electrically insulated by a non-conductive plate 127 from the enclosure and movable along the axis of the enclosure.

The hexagonal shape of the shield or enclosure allows for a honey-comb type of arrangement for a continuous pattern of sensing without the gaps as would exist with round enclosure. The sensitive element inside of the enclosure is the sensing antenna element and may have a hexagonal shape spacer or plate 127 that maintains the perimeter and the enclosure inside surface equidistant. The sensitive element is connected to an integrating amplifier input via a shielded wire or coaxial cable. However, the shield or enclosure may have other cross-sectional shapes, including, for example square or circular.

The ability of the sensing antenna element to move along the axis of the enclosure varies the profile of the sensing pattern. When the antenna element is near the open end, the sensing pattern is nearly hemispherical in shape. When the antenna element is near the back of the shield or enclosure the sensing pattern approaches cylindrical shape.

When the shields or enclosures are mounted into an array, as in a honey-comb arrangement, the active element is located back from the open end of the shield or enclosure. This reduces the sensitivity from angles beyond the sides of the shield or enclosure producing a location specific sensing of the array.

Referring to FIG. 7, the antenna may be a slotted cylinder 122 which results in an ellipsoidal pattern 124.

Moreover, the E field sense antenna as illustrated in FIG. 8 may be a rod 110 disposed in a flow tube 130 which contains charged particles all traveling in the direction of arrows 132. As will be discussed hereinafter this particular configuration is uniquely suitable for measuring charge rates or for use in particle counting.

Referring now to FIG. 9 an antenna configuration is shown in which charge particles travel long the direction of arrow 132 where they impinge upon ball 112 on top of rod 110, thereby providing a detected charge. It will be appreciated that rod 110 is disposed in a conductive cylinder 134 so that the measurement of charged particles is within a so-called faraday cage.

Referring to FIG. 10 a second rod 110′ can be located ahead of rod 110 within conductive housing 134 such that charges picked up by rod 110′ may be compared with those picked up by rod 110 to give a more accurate count for particle counting purposes.

As to particle counting and as illustrated in FIG. 11, rod 140 is coupled to a high gain low noise amplifier 142 that is in turn coupled to a frequency profiling and nonlinear gain module 144. This module performs analog signal processing to reject background levels of noise and charge.

The output of module 144 is applied to a dynamic threshold detection circuit 146, the output of which is coupled to a software module 148 for performing count rate mathematics and accumulation under user control and predetermined parameters. The output of module 148 is particle count rate 150 or total particle count 152.

Because of the aforementioned circuitry and the unique sensor configuration with the sensor rods within the conductive conduit, accurate particle counting is accomplished.

Referring now to FIG. 12, it will be appreciated that the aforementioned E field sensing system may be utilized for hand gesture recognition in which the motion or position of hand 160 either back and forth as illustrated 162, up-and-down as illustrated 164 or left and right illustrated 166 is sensed by a sensor plate 170 having nine segments 172 that are used in determining where in space various parts of hand 160 are located. It will be appreciated that the sensor plate is coupled to a gesture detection module 174 in turn coupled to a machine control interface 176.

In operation, the ability to sense tiny changes in the ambient E field makes possible detecting hand movements in front of a sense antenna without emitting energy or fields and regardless of lighting or temperature in a no touch system. The segmented antenna design is used to assess the field in front of a single multiple element sense plate. Signal processing produces an interpretation of the sensed pattern or movement that produces one or more separate control signals that can be used for machine control in order for instance to turn on, turn off, and adjust color, direction, or other parameters.

It is noted that the front or back of the hand can be used for the basic 28 different patterns, with extended fingers requiring the hand be placed with the fingers approaching the sense plate. This application can be best implemented by placing nine sensor targets to guide the hand positioning. If just basic movements are to be used, the sense plate may be blank with just an outline or simple plastic plate cover mounted on the wall.

Movements include, beyond the six basic movements shown above, are diagonals, circular movements and the speed of movement that may be used as discriminators. This means a potential of 28 different movement patterns, depending on the density of the sense plate and the support electronics. In addition, extended finger patterns can produce an additional patterns for decoding, increasing the interpretive combination of control functions to a potential of 73.

Different from capacitive touch controls and touch sensitive screens, E field technology works without physical contact. Thus, the subject system is used to detect hand movements without touching a sense plate.

It is therefore possible to effectuate machine control by merely gesticulating one's hand in front of the aforementioned sense plate which senses the pattern of the hand and where in space the hand is located, thus to be able to discern both the hand pattern and movement of the hand to create various control signals.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for visualizing an E field comprising:
utilizing an E Field sensor to sense charge in a volume;
processing the output of the sensor to produce a mosaic corresponding point by point to the detected charges and the location of the charges such that the mosaic constitutes a visualization of the pattern of the E Field in the volume, with the mosaic having image or picture elements correlated in space to corresponding charges that generate the E Field.

2. The method of claim 1, characterized by one or both of the following features:
(a) wherein the image or picture elements in the mosaic represent static charge of the E Field in the volume; and (b) wherein the image or picture elements in the mosaic correspond to a conductive, partially conductive or non-conductive object moving in the E Field, wherein an image or picture element preferably corresponds to the disturbance of the E Field due to the motion of the object identified as a moving object, and wherein the output of the sensor preferably is amplified and threshholded such that only those objects moving on the E Field produce signals above the threshold.

3. The method of claim 1, wherein the visualization includes one dimensional, two dimensional or three dimensional images.

4. The method of claim 3, wherein the sensor includes at least two mutually orthogonal antennas thereby to permit the formation of a two dimensional image of the E Field, optionally further including an additional orthogonal antenna, the antennas oriented along an X axis, a Y axis and a Z axis respectively to permit the rendering of a three dimensional image of a charged object with the volume, and optionally further including providing quantitative information regarding charge magnitude of a charge in the E Field and for presenting the quantitative information onscreen, wherein separate positional information for a charge in the E Field preferably is presented onscreen.

5. The method of claim 4, and further including multi-channel processing from the three mutually orthogonal antennas to permit rendering of a multi-dimensional image of the detected E Field, wherein the multi-dimensional image preferably is generated from three dimensional software, wherein the three dimensional software preferably provides both measurement data and a volumetric image onscreen.

6. The method of claim 1, wherein the output of the sensor is detected by highly sensitive electronics wherein the highly sensitive electronics preferably include an analog circuit having a high impedance, low noise amplification characteristic, wherein the analog circuit preferably includes an integrating amplifier connected to the sensor with the output of the integrating amplifier coupled to an input to an integrating feedback amplifier having an output coupled through a non-linear device to the sensor, wherein a closed feedback loop consisting of the non-linear device, the integrating amplifier and the integrating feedback amplifier preferably establishes a base band against which E Field changes are compared at the input of the integrated amplifier, wherein the output of the integrating feedback amplifier preferably is used to cancel the input charge on the sensor to drive the output of the integrating amplifier to zero, wherein impedance of the non-linear device preferably is low when there is a voltage difference between the sensor output and the output of the integrating feedback amplifier, wherein when balance preferably is reached there is a small potential difference at the sensor and wherein the non-linear device exhibits a high impedence for low noise E Field detection, and optionally further including amplifying the output of the integrating amplifier, wherein the amplified integrating amplifier output preferably is threshholded to discriminate against predetermined small E Field changes yet indicates when large changes have occurred, and wherein the analog circuit preferably permits real time three dimensional imaging that permits visualizing the E Field in terms of a visually accurate image of the location of charged objects within the volume.

7. The method of claim 1, wherein the sensor includes an omni-directional antenna comprising a rod with a ball at the distal end thereof.

8. The method of claim 7, wherein the sensor is given a directional characteristic by inserting the rod and ball in an open ended conductive shield,
wherein the degree of directionality preferably depends upon the length by which the rod and ball extends into the conductive shield,
wherein the conductive shield preferably has an hexagonal, square or circular cross section, and
wherein the rod and ball preferably is spaced from the interior side of the hexagonal, square or circular shaped shield by use of a non-conductive plate supporting the rod.

9. The method of claim 1, wherein a sensor includes a split cylinder giving the antenna an ellipsoidal directionality.

10. The method of claim 1, wherein the sensor includes a rod with a ball at the distal end thereof and a conduit, the rod and ball extending into the conduit and further including passing a fluid down the conduit, the rod and ball detecting the number of charged particles passing the rod and ball.

11. The method of claim 10, and further including an additional rod and ball spaced from the first mentioned rod and ball within the conduit,
wherein a sensor preferably is utilized to detect a particle count rate or a total particle count,
wherein the output of the antenna preferably is applied to a fast high gain low noise amplifier,
wherein the fast high gain low noise amplifier preferably is coupled to a frequency profiling a non-linear gain module for rejecting background noise levels,
and optionally further including dynamically threshholding the output from the frequency profiling and a non-linear gain module and coupling the dynamically thresholded output to a software module performing count rate mathematics and count accumulation.

12. The method of claim 1, and further including utilizing the sensed E Field for hand gesture recognition.

13. The method of claim 12, wherein the sensor includes a segmented planar sensor adapted to be able to locate portions of a person's hand and to recognize a predetermined gesture from the sensed position of the various parts of the person's hand as detected by the segmented sensor, optionally
further including processing the output of the segmented sensor for gesture detection,
and optionally further including the step of utilizing the output of the gesture detection for machine control.

14. Apparatus for visualizing an E Field comprising:
an E Field sensor; and,
an E Field imager coupled to said E Field sensor for rendering a representation of the sensed E Field in terms of image or picture elements having a location and magnitude corresponding to the location and magnitude of a charge in a volume.

15. The apparatus of claim 14 characterized by one or more of the following features:
(a) wherein the imager operates in real time to produce said rendering,
(b) wherein said rendering is done in one, two or three dimensions, and
(c) wherein the output of said E Field sensor is processed by a high impedance, low noise amplification circuit, and
wherein said amplification circuit preferably is an analog circuit, and
wherein said analog circuit preferably includes an integrating amplifier coupled to the output of said E Field sensor, an integrating feedback amplifier coupled to the output of said integrating amplifier, and a non-linear device coupled from the output of said integrating feedback amplifier to said E Field sensor.

16. An E Field sensor system, comprising: an E-Field sensor and a high impedance, low noise amplifier coupled to said E Field sensor.

17. The apparatus of claim 16, characterized by one or more of the following features:
(a) wherein said amplifier includes an integrating amplifier coupled to the output of said E Field sensor, an integrating feedback amplifier coupled to the output of said integrating amplifier, and a non-linear device coupled from the output of said integrating feedback amplifier to said E Field sensor;
(b) wherein the output of said amplifier is used for rendering an image of said E Field;
(c) wherein the output of said amplifier is used in particle counting,
(d) wherein the output of said amplifier is used for hand gesture recognition,
(e) wherein said E Field sensor includes a rod,
wherein said rod preferably has a ball at the distal end thereof,
(f) wherein said E Field sensor has an omni-directional characteristic,
(g) wherein said rod is mounted in an open-ended shield to give said sensor a directional characteristic,
wherein said shield preferably has a hexagonal, square or circular cross section,
(h) wherein said rod is a conduit split longitudinally to provide an ellipsoidal characteristic,
(i) wherein said rod is disposed in a conduit adapted to conduit fluid past said rod, and
(j) wherein said E Field sensor includes a segmented planar array of sensor elements.
